(19) United States
(12) Patent Application Publication
(10) Pub. No.: US 2005/0274035 A1
(43) Pub. Date: Dec. 15, 2005

(54) Waste handling system

(75) Inventors: Thomas R. Beal, Newbury, MA (US); Richard H. Edgar, Chelmsford, MA (US)

Correspondence Address: OBLON, SPIVAK, MCCLELLAND, MAIER & NEUSTADT, P.C., 1940 DUKE STREET, ALEXANDRIA, VA, 22314, US

(73) Assignee: Wastech International, Inc., Portsmouth, NH (US)

(21) Appl. No.: 11/144,838

(22) Filed: Jun. 6, 2005

Related U.S. Application Data
(60) Provisional application No. 60/576,823, filed on Jun. 4, 2004.

(51) Int. Cl. F26B 19/00; F26B 11/02

(52) U.S. Cl. 34/63; 34/108

(57) ABSTRACT

A waste conditioning or processing arrangement is provided which can effectively handle waste at its point of generation. In a preferred arrangement, the waste is conditioned by drying the waste and forming the waste into pellets or granules, with the waste also preferably sterilized during the conditioning. The resulting pelletized or granularized waste is remarkably smaller than the input waste, and can conveniently be stored for subsequent disposal or use. The arrangement can be used in a variety of contexts, and is particularly advantageous for food or organic wastes. The system can be used in restaurants or marine vessels for handling kitchen or galley waste. The system can also be advantageously used for certain agricultural waste.

### CROSS-REFERENCE TO RELATED APPLICATIONS

This application is related to, and claims priority to, co-pending application Ser. No. 60/576,823 filed Jun. 4, 2004, the contents of which are incorporated herein by reference.

### BACKGROUND OF THE INVENTION

1. Field of the Invention

The present invention relates to a system and method for handling and treating waste material. The invention is particularly advantageous for handling and treating food waste at a source where the waste is generated, for example, on marine vessels or in restaurants.

b 2. Discussion of the Background

Waste generated on marine vessels must be treated and disposed of in an efficient and environmentally optimal manner. The waste may include food waste which is “sloppy” because of a relatively high water content. The need to properly dispose of food waste can be particularly problematic for large vessels, such as Naval or commercial cruise ships, due to the large number of personnel or passengers, and/or the length of time that can elapse between suitable locations at which food waste can be disposed. Typical kitchens or galleys of such vessels can generate large quantities of food waste at each meal.

One manner of food waste treatment is to grind the food waste in a pulper, which uses water to transport the food through the grinder similar to a garbage disposal found in many commercial kitchens. The ground food waste is then disposed over the side of the ship into the ocean. However, environmental regulations prohibit this manner of disposing of food waste for cruise and Naval vessels within littoral waters that extend 12 nautical miles from the shoreline. Consequently, the food waste will either require storage until the ship is farther than 12 nautical miles where disposal is possible, or implementation of another appropriate manner of treating the waste for disposal. Moreover, even though food waste disposal is permitted outside of the twelve mile limit, such disposal is obviously less than optimal environmentally. Further, storage of the waste until a suitable disposal location is reached can be problematic from a standpoint of the volume of the waste and also problems associated with, e.g., decay, bacterial and/or fungal growth associated with the waste. Accordingly, an improved system and method for treating food waste generated on marine vessels (or at other sources) is needed. The present invention addresses this need. In one exemplary embodiment, the invention also reduces the load on the ships wastewater treatment system by treating waste in the galley that may otherwise be sent to the ship's wastewater treatment plant. The invention is not limited to the above-discussed embodiments, and can also be used for other waste disposal applications, some examples of which are discussed herein.

### SUMMARY OF THE INVENTION

It is an object of the present invention to provide a system and method for handling and treating waste.

It is another object of this invention to provide a system and method that is very compact and suitable for “retro-fit” as well as new applications where floor space is at a premium.

It is a further object of the invention to provide a system and method which can convert waste, for example food or organic waste, into a substantially sterile or inert and dry product, preferably in granular or pellet form. In this form, the volume of the waste is significantly reduced and problems associated with smell, bacterial and/or fungal growth are avoided or minimized. Optimally, the waste can be continuously dried to form pellets or granules by employing electric heat, steam or other heat sources.

One non-limiting embodiment includes, a treatment apparatus, including, an accumulator configured to accumulate waste and to deliver the accumulated waste in a continuous manner, and a conditioner configured to receive the accumulated waste and to heat the waste to remove liquid from the waste, the conditioner comprising a set of cooperating blades configured to convey the waste through the conditioner.

Another non-limiting embodiment includes a method of treating waste, including accumulating waste in a non-continuous (batch) manner, delivering the waste to a conditioner in a continuous manner, heating the waste in the conditioner to remove liquid from the waste, and conveying the waste through the conditioner with a set of cooperating blades.

Another non-limiting embodiment includes a treatment apparatus, including, an accumulator configured to accumulate waste and to deliver the accumulated waste in a continuous manner to a means for receiving the accumulated waste, a means for receiving the accumulated waste, and a means for heating the waste to remove liquid from the waste.

The heating and drying can optionally be augmented by microwave heating. Accordingly another object of the invention is to provide a waste treatment system that utilizes a microwave assisted drying process. Where microwave assisted drying is employed it offers the benefits of inhibiting the formation of highly viscous, tightly bound mass concentrations of waste material that can be difficult to granulize. This phenomenon plagues conventional dryers causing high motor torque demand and the formation of “cement like” layers of material that adhere to heat transfer surfaces and impede heat transfer. The use of microwave energy preferably pulsed with a peak to average power ratio of two or more, results in internal heat generation that liberates steam faster than it can migrate through the material being dried. The resulting internal pressure breaks up the material and inhibits the formation of tightly bound mass concentrations. The use of pulsed microwave energy also results in periodic thermal expansion and contraction of the material being dried that fatigues bonds at the boundaries between individual granules. This effect further inhibits the formation of tightly bound mass concentrations. Where microwave energy is employed to assist the drying process, the arrangement can include a microwave feed antenna with a microwave chamber formed in which the microwave heating acts in conjunction with other heating expedients.

The dried product can be stored for: (a) subsequent incineration at another location, (b) subsequent disposal without incineration, or (c) subsequent use, for example, as a fertilizer or soil enrichment product or as an animal food additive.

In accordance with one example of the invention, heat is introduced through a rotating auger or mixer that is oriented along the central axis of the dryer or conditioner apparatus. This approach provides advantageous energy efficiency, since the heat must pass through the material being dried. The relatively small diameter (heat transfer cross section) of the central auger(s) axis can also form a natural “heat-choke” that inhibits heat loss. The preferred heat transfer medium is a constant temperature heat transfer fluid such as steam or other suitable medium provided by a separate heat exchanger or an existing heat source, although where other sources are not readily available an electric heat source may be used.

In accordance with another advantageous aspect, a system and method is provided that employs one or more multi-function central axis augers to heat, mechanically condition and transport the material being dried through the dryer. The auger preferably has a multiplicity of fins arranged in one or more rows. For one exemplary embodiment, in each row, the fins have a uniform pitch and cross section, but both the pitch and cross section can vary from row to row for optimum heat transfer, mechanical conditioning and transport control. Fin length and cross sectional area are chosen to enhance heat transfer to the material being dried. The variable row to row pitch may be employed to control the amount of material dwell time within the various zones within the dryer. The row to row variable cross section of the fins may optionally be selected to mechanically slice or crush the material as it is encountered by the fins and passed through the drier.

Another object of the present invention is to provide a system which can treat organic food waste at the point of generation, for example, located in the kitchen of a restaurant or galley of a marine vessel.

Another object of the invention is to allow for scalability of devices in order to accommodate increased waste disposal needs.

Another object of the invention is to provide a system that can accommodate irregular or random waste input while achieving continuous processing of the waste.

Yet another object of the present invention is to provide a system which produces by-products that comply with environmental regulations.

Yet another object of the invention is to employ energy conserving heat recovery to preheat air required to remove moisture liberated by the drying process. Preheating has the effect of lowering the relative humidity of the air and insuring, with the correct air flow, sufficient capacity to remove the moisture liberated by the drying process.

A still further object of the present invention is to provide a system which produces pellets, or in other words, granules from the waste with a low moisture content, with a water content less than about 50% and preferably less than about 15%. The terms granules or granularized and pellets or pelletized are used interchangeably herein and are intended to broadly mean particles or discrete portions, without being limited to a particular size or shape of the particles or discrete portions and without in and of itself (unless specifically noted in the disclosure and the appended claims) being limited to a specific process for forming the granules or pellets. Using apparatus as disclosed herein, an end product similar to dry, coarse coffee grounds is produced on the downstream side of the dryer/conditioner apparatus. This product can be conveniently stored for subsequent disposal or use.

The above and other objects and advantages are achieved by a system and method of the present invention. Waste, such as food matter, can be initially introduced into a collection device which directs the waste to a grinder. The grinder grinds the waste into particles of a smaller size, preferably without additional water (i.e., in contrast to conventional kitchen-type garbage disposals which require water to carry the waste through the unit). Ground waste is deposited into a retainer which serves as a surge volume and supply for waste, with the waste conveyed at a controlled rate to the dryer. In some applications the food waste arrives at the food waste dryer in a slurry form. In these cases grinding is not required.

The waste is then moved to a dryer or conditioner which decreases the water content of the waste. In some embodiments of this invention, the dryer raises the temperature sufficiently for a sufficiently period of time to achieve sterilization and convert the waste material into a non-hazardous state. The resulting product can be subsequently disposed of or used in various manners. For example, the resulting product can be incinerated where the waste is generated, if such facilities are readily available, such as in existing naval solid waste incinerators. The waste is also suitable for storage to be incinerated at a later time and/or place, or for other disposal or use. For example, as noted earlier, the resulting products could be utilized for agricultural purposes or as an additive for animal food products. Alternately, the waste could be discharged overboard, in a landfill, or other suitable disposal locations. The drying and conditioning is extremely beneficial where the waste is not subsequently incinerated or where the incineration is to occur at a later time. In the conditioner, the waste is heated and dried to significantly reduce the volume and mass of the waste, and to kill bacteria and viruses and/or render the waste sterile. As a result, even if the waste will not be incinerated or otherwise disposed of shortly after conditioning, it can be stored more safely and conveniently. The waste need not ultimately be incinerated. The drying and conditioning provides a resulting product which is substantially inert due to its dry and sterile or inert nature, and also due to the significantly reduced volume of the end product as compared with the incoming food waste.

As noted above, the waste could be disposed of without incineration, or could otherwise be used, e.g., as an agricultural product. By way of example, vineyards and other agricultural producers often have significant amounts of waste, e.g., skins remaining after crushing, e.g., grapes. Although this material can be useful in conditioning or amending the soil, there is often a reluctance to use this material for fear of fungus and other concerns. By conditioning the waste material, it can be safely returned to the soil to reduce handling/removal costs of the material and/or to provide an agricultural benefit to the soil. In a particularly preferred form, the conditioner which removes moisture and heats the waste also forms the waste into granules or pellets as the waste passes through the conditioner. This can be performed by, e.g., an auger or moving blade arrangement or another device provided to reduce or work the waste into a pelletized or granular form as it is conditioned.

As an alternative to forming the waste into pellets or granules as it is conveyed through the conditioner, or in order to further breakdown the waste after it has passed through the conditioner, additional cutting, grinding or milling expedients can be provided downstream from the conditioner. The provision of additional cutting or milling expedients will depend upon the form of the waste as it exits the conditioner. In the presently preferred form, the waste exits the conditioner sufficiently granularized such that further breaking down of the waste is not necessary. The conditioner as described herein can produce granules having sizes on the order of ⅛″ to 1/32″ in size, for example, with the resulting product thus quite convenient for storage and/or subsequent handling. However, it is to be understood that additional cutting or milling of the waste could be provided downstream of the conditioner in order to supplement the granularization/pelletization of the waste as it passes through the conditioner, or if the configuration of the conditioner with expedients is such that additional cutting or milling of the waste is desirable.

In accordance with an additional advantageous aspect of the invention, it has been recognized that the results of the conditioner are further improved by an alternating back and forth feeding or, in other words, forward and reverse conveyance. With this arrangement, the wetter material is held in the upstream side of the conditioner for a longer period of time, and moreover, the forward and backward movement causes mixing of waste being introduced with waste that was previously introduced, and also mixing of waste at various stages along the conditioner. In accordance with this feature, the conditioner can operate more efficiently, and can be more compact in size.

As noted earlier, after the waste is conditioned and formed into pellets or granules, it can be stored for subsequent use, e.g., for agricultural uses, or the waste could be stored for subsequent disposal or incineration.

Although the various components of the system and method of the present invention can be used in combination for treating food waste, it is to be understood that various components or subsystems have advantageous utility for a wide variety of applications, and all components of the system are not required for providing an improved food waste (or other waste) treatment system. In other words, various combinations of the components could be utilized in a given system depending upon, e.g., the needs of the system, cost constraints, etc. In addition, although the system is particularly desirable for marine applications, other moving or stationary sources could also advantageously utilize various aspects of the invention such as farms/agricultural facilities, rail systems, restaurants, hotels and institutions.

The invention will be further appreciated from the detailed description of examples herein. It is to be understood, however, that in practicing the invention, a given embodiment need not have each and every feature of an example or examples disclosed herein and/or might not achieve all of the potential advantages of the preferred example or examples described herein. For example, in practicing the invention, one might choose to utilize certain features of the preferred embodiments disclosed herein, but not others, and thus, an embodiment following the teachings of the present invention could be constructed by utilizing a subset or subsets of one or more of the preferred examples disclosed herein.

### BRIEF DESCRIPTION OF THE DRAWINGS

A more complete appreciation of the invention and many of the attendant advantages thereof will become readily apparent with reference to the following detailed description, particularly when considered in conjunction with the accompanying drawings, in which:

FIG. 1 illustrates a side view of the waste treatment system of the present invention;

FIG. 2 illustrates a block diagram of a process flow of the waste treatment system of FIG. 1;

FIG. 3A-3D further illustrate features of the waste treatment system and particularly a presently preferred conditioner apparatus according to the invention; and

FIG. 4 illustrates a further example of a system according to the invention.

FIG. 5 is a flowchart of one embodiment a method according to one embodiment of the invention.

### DETAILED DESCRIPTION

The preferred embodiments will now be described with reference to the accompanying drawings, wherein like reference numerals designate corresponding or identical elements throughout the various drawings.

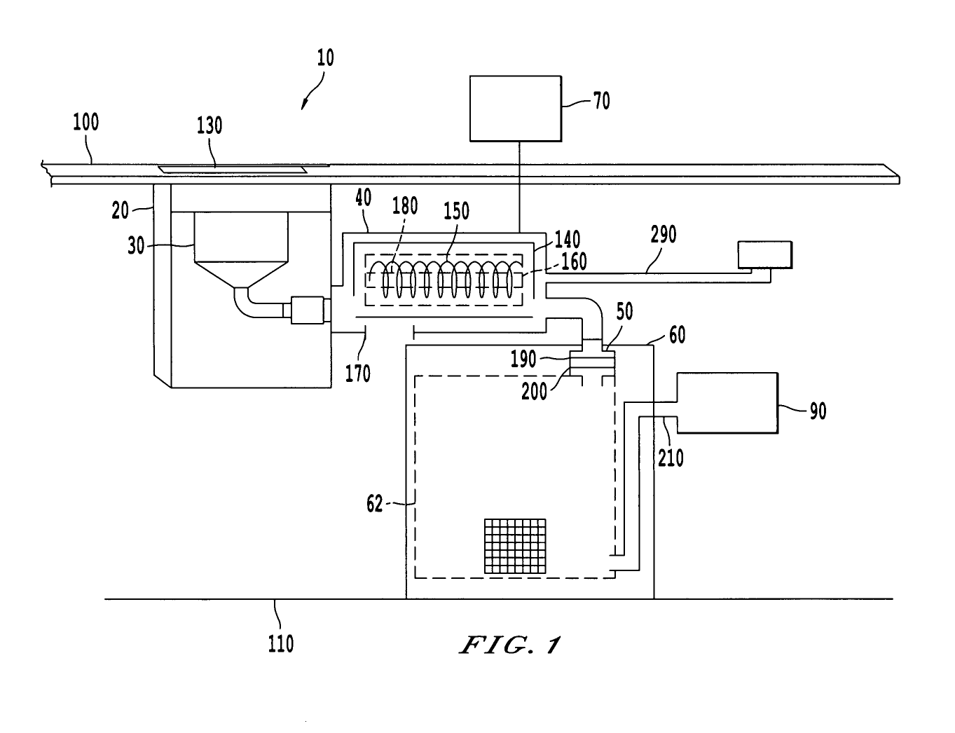

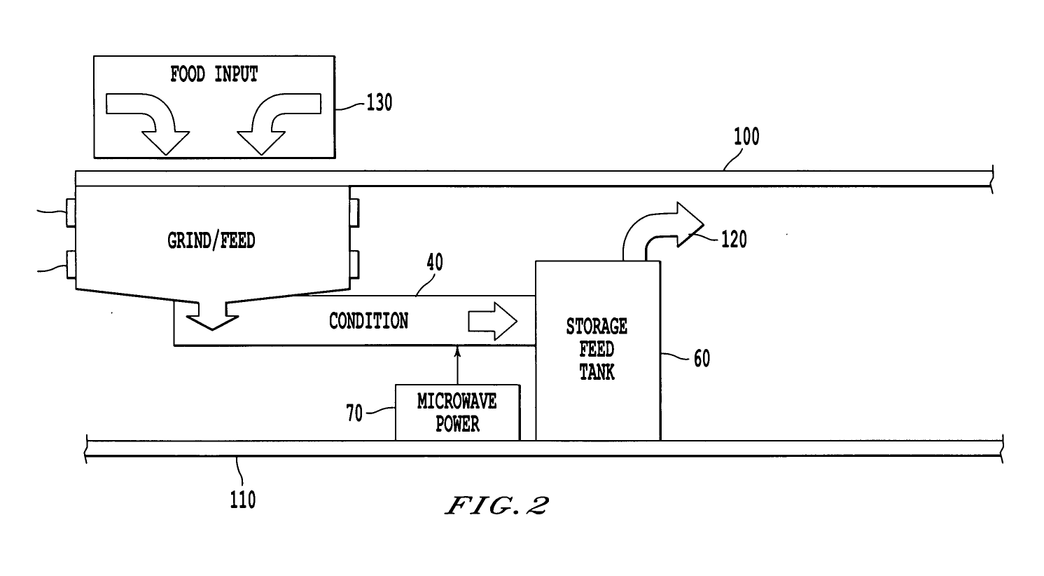

Referring to the example of FIG. 1, the system 10 can include a collection device 20, a grinder or reducing device 30, a conditioner 40, a further reducing or grinding device 50, a feed tank 60, a microwave drying power source 70, and a removal system 90. The system 10 may be installed such that the accumulator or collection device 20 is supported below a counter 100 and is supported, e.g., on the floor 110 of a marine vessel or restaurant kitchen. Alternatively, it should be appreciated that the system 10 may be installed on any other surface or located anywhere such a treatment system is desired to effectively treat and dispose of food waste, particularly near the source of the food waste. Although only one system is shown in FIG. 1, it should also be appreciated that any number of systems may be installed in a ship or other location, depending on the amount of waste that requires processing. For example, a cruise ship may require installation of twenty systems, whereas an aircraft carrier may require between five and ten systems. In addition, the sizes of the various components can be varied for different capacity capabilities. It is also to be understood that a given system could be composed of a subset of the elements shown in the various drawings, and/or the locations of various components can be provided otherwise than as depicted. Also, although the system of FIG. 1 depicts a grinder upstream of the conditioner and additional cutting or grinding downstream of the conditioner, one or both of these could be eliminated depending upon the waste being handled and/or the configuration of the conditioner. For example, according to one form of the invention as discussed herein, the conditioner includes a feeding arrangement that can break down or comminute the waste such that further downstream cutting or grinding is not necessary. Further, where the waste is agricultural waste, conventional agricultural processing equipment (e.g., a chipper) may provide a suitable waste product such that additional grinding when the waste is initially introduced into the system is not needed. Where the system is utilized for food waste remaining from a meal/food service facility (e.g., on board a ship or in a restaurant), the waste is preferably ground when initially introduced into the system, but in contrast to conventional disposers, preferably the waste is ground in grinder 30 without introducing additional water. It is to be still further understood that the system can be used in various locations, and is not limited to use in restaurants and ships, but can be used in any setting in which waste treatment is desired.

The collection device 20 can include a cover (not shown in FIG. 1) which easily lifts up to expose a food input opening 130. Food input 130 is disposed at the collection device 20 and can be provided, for example, at a location where the food waste is removed from dinnerware and cookware, or alternatively, food waste can be collected in containers and dumped into the input 130. Although the arrangement and method of the invention can accommodate most typical food wastes remaining after food preparation and dining, in certain applications, it could also be advantageous to segregate certain food wastes such that certain waste is dried with the assistance of microwave power while other waste is not.

The food waste collected in the collection device 20 is preferably not mixed with water, but rather is simply scraped from the dinnerware and cookware. Typical food waste will have a “sloppy” consistency of about 90%-95% water. Preferably, no additional water is added when the waste is introduced into the system.

The food waste then moves to the grinder or reducing device 30 which grinds the food waste into smaller sized particles which are more easily moved through the system. The grinder 30 is preferably a waterless system (i.e., in contrast to a typical food disposal which uses water as a carrier) which operates by gravity or any other appropriate feed. The waterless system is beneficial because without the addition of more water to the system, it is more energy efficient and easier to process the waste into a form that can be readily handled. A non-limiting example of a grinder 30 can include a hammermill or a series of rotating wheels to cut the food waste. It should be appreciated, however, that the grinder 30 may include heavy duty grinders if, for example, the waste will include steak bones, lobster shells or other similarly hard to grind food waste. Alternately, a less heavy-duty grinder could be utilized if, for example, large bones and the like are to be removed from the waste before the waste is introduced into the system. Particularly for large scale operations where pre-separation of the waste is inconvenient, the system is preferably able to accommodate bones and other hard to grind waste.

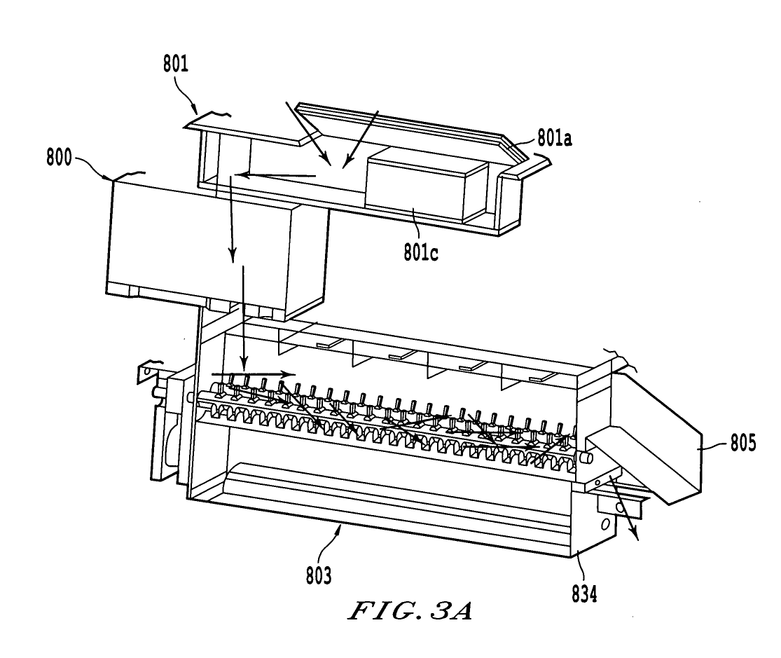

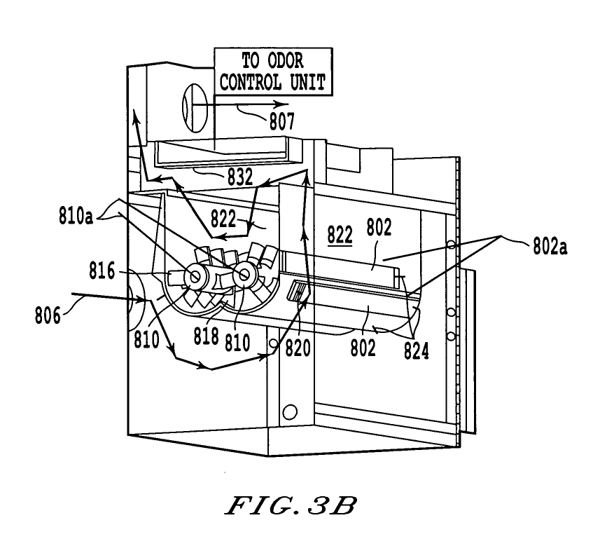

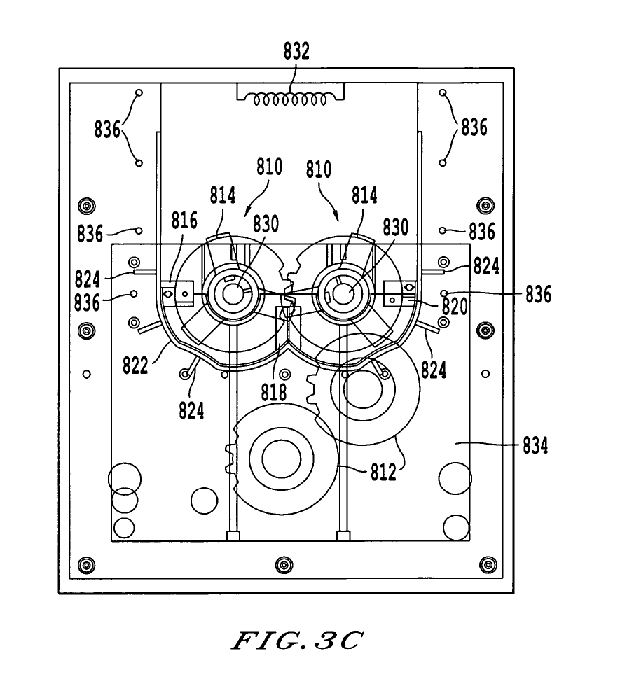

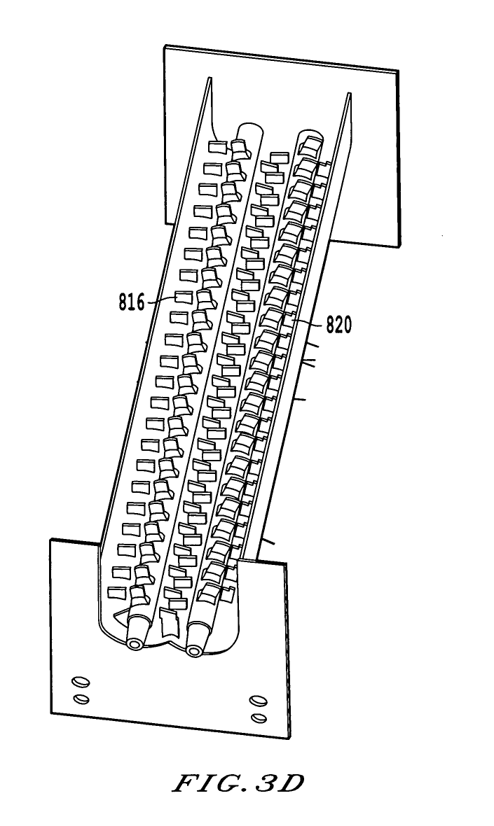

The food waste then continues through the conditioner 40. The conditioner 40 includes a housing or chamber 140. The housing 140 has a conveying device 150, one non-limiting example of which is an auger. As discussed in further detail hereinafter, according to a particularly preferred form, the conditioner can advantageously include two (or more) rotating bladed shafts in order to reduce, stir/agitate/mix, heat, and convey the waste as it passes through the conditioner. The feed device or conditioner can also include a containment device 160. For example, a wire or grid formed into a cylindrical shape could be provided about an auger feed device 150, or a cylinder or curved surface or jacket could be provided to retain the waste during conveyance and having openings to allow drainage. A drain 170 can optionally be formed in the bottom of the conditioner 40 to allow some of the excess moisture to drain away from the food waste and out of the conditioner 40. A further example of a particularly advantageous arrangement is discussed hereinafter with reference to FIGS. 3A-3D.

The conditioner includes one or more expedients to dry the food waste as it is conveyed therethrough. The drying expedients include passing dry air over the waste to capture and remove water vapor liberated as the waste is dried, the provision of heating elements to heat the waste and the provision of a microwave power source to augment the heating of the waste. The air may be preheated by first passing it through the annulus formed between the drying chamber and the external dryer insulation whereupon it is then directed over the bed of material being dried in order to capture the moisture liberated by the drying process. The heating elements can include electrical heating devices or fluids (i.e., steam or other heat transfer fluid) which directly heat the surfaces (e.g., the jacket or containment structure 160 and/or housing 140) that the material being dried comes in contact with as it passes through the conditioner. These heating sources may be used to heat the outer wall of the chamber through which the material passes and the interior of the augers or stirrers employed to convey and condition the material. The dominant mode of heat transfer with these sources is conduction. Additionally, microwave energy may be introduced into the chamber to heat the material in depth directly (i.e., instantaneous, internal heat generation). A microwave power source is schematically represented at 70. It has been recognized that the use of microwave power to augment other heat sources is particularly advantageous at the downstream end of the conditioner as the waste is in the later stages of drying. The entire interior of the conditioner can be constructed as a microwave chamber, with suitable microwave traps to prevent undesired escape of microwave radiation. Alternatively, the interior of the conditioner can be divided with suitable microwave traps so that only a portion, for example, the downstream portion, is subjected to the supplemental heating/drying with microwave energy. This method of heating has the advantage of “puffing” the material which has the desired effect of reducing the tendency of the material to form undesirable highly viscous (stiff) clumps that are extremely difficult to shear. Additionally, the microwave energy may be pulsed (i.e., high peak power to average power ratio) in order to enhance the puffing and further speed the drying and help granularize the material. As should be apparent, various forms of heating and/or drying expedients can be utilized, alone or in combination.

In the arrangement schematically represented in FIG. 1, the heating device, represented schematically at 180, may be disposed within and/or surrounding or adjacent the conveying device 150 (an auger or rotating bladed shaft as discussed further hereinafter). The heating element 180 heats the chamber 140 and/or conveying device 150 to temperatures such that thermal energy is transmitted to the food waste. Warm air is introduced (as schematically represented at 290) to remove the water vapor and prevent or reduce condensation rather than to heat the food waste (although heating of the food waste could result). The air temperature and flow can be varied according to the drying (moisture liberation) rate. The heated air carries away the liberated moisture. In other words, where air is introduced such that it contacts the waste, for most configurations, this air will be used for removing moisture from the conditioner rather than for bulk heating and extracting of moisture from the waste. Where the food waste is heated to evaporate or extract moisture from the food waste, other expedients (including but not limited to one or more of electric heating, fluid heating and microwave heating) are preferably employed because drying of high density, thick, bulk materials with air is inefficient. If it is desired to use air in the drying process it is best employed at the tail or downstream end of the dryer where the material has become at least partially granularized.

The increase in temperature of the food waste from thermal conduction, internal heat generation, and/or convection evaporates the water from the food waste. In addition to removal of the moisture, heating and drying of the food waste can have the additional benefit of killing bacteria or fungus that could be present in the waste. In addition, because the waste is substantially dry after processing, it is less susceptible to subsequent growth of bacteria or fungus. This benefit is particularly beneficial where the waste either is not subsequently incinerated or where the waste will be stored for a significant period of time for subsequent disposal by incineration or otherwise. Particularly where the waste is to be stored for a substantial period of time for subsequent disposal or incineration, or where the waste is to be otherwise used (e.g., for enhancing soil), the waste is typically heated to at least 212° F., more preferably to at least 220-250° F. in the conditioner to reduce or eliminate bacteria or fungus.

The food waste then moves to the storage tank 60. Optionally, a grinder or cutting device 50 can be provided at an inlet to the feed tank 60. For example, as represented schematically, the device 50 can include a screen 190 and a cutter 200. The screen 190 can be sized and shaped such that the food waste is pushed through openings in the screen, to form plural extrusions that are then cut by the cutter 200 into a desired length to form granules having a surface area which provides more optimal packing density. Depending upon the length of the passage between the conditioner 40 and the tank 60, additional feeding or conveying devices could optionally be provided along the passage. Other expedients such as a mill could also optionally be utilized to form granules. Such a mill could be provided at the inlet to the tank 60 or at another location between the outlet of the conditioner 40 and the inlet of the tank 60. Alternately, as mentioned earlier, if the waste exits the conditioner 40 in a form such that additional cutting/grinding is not needed, the waste can exit from the conditioner 40 into the storage tank 60 without further grinding/cutting. As discussed further herein, it is particularly preferable if the conditioner arrangement is configured such that further cutting, grinding or reducing of the waste downstream from the conditioner is not needed.

As noted earlier, after the conditioning, the waste can simply be stored for later disposal. For example, where the waste is generated on a marine vessel, the waste could be stored on the ship for subsequent disposal or use. Where the waste is to be stored, a removable container or liner represented at 62 in FIG. 1 can be provided. With this arrangement, the container can be conveniently removed, and dumped into a larger storage container, or a plurality of such containers (or container liners) can be utilized as the storage vessel. By way of example, a plurality of container bins 62 could be provided so that each time the bin is filled, it can be removed and replaced with another bin, and the bin 62 can be utilized as a storage container with an appropriate lid until subsequent disposal or use of the waste is convenient. Where the system is utilized on a marine vessel, it may be preferable to provide the containers as nestable containers to minimize the storage requirements for the replaceable containers. As an alternative, the bin 62 can be removed and dumped into a larger storage container. Further, if desired, an automatic conveying expedient could be utilized to remove waste that has collected in the storage container or bin 62. For example, with an auger or vacuum pressure schematically represented at 90 could be used to remove the end product through a conduit represented at 210. Alternatively, a trap door could be provided at the underside of the storage container 62 so that when the trap door opens the waste product is dropped into a larger storage container. As discussed earlier, after processing, the waste is suitable for storage or subsequent disposition or use. Alternately, the waste is also suitable for incineration, for example, in a conventional incineration apparatus available on naval vessels.

Thus, as should be readily apparent, various system configurations are possible. The configuration of the system will depend upon a number of factors, including the waste handling demands and the type of waste being handled, and possibly the limitations of the facility where the waste is to be handled. In addition, the size and/or number of systems can vary. For example, for a large scale operation, the size of the system can be increased, or alternatively, a number of separate systems can be utilized. Further, for certain waste, it might be desirable to reuse the waste, for example, where the waste is agricultural waste (e.g., grape skins from a vineyard) in order to fertilize or enrich the soil. Significant benefits are achieved by the conditioning and drying in dramatically reducing the size of the waste. Preferably, the conditioning will reduce the volume of the waste by at least 70%. Reductions of up to 90% of the volume have been achieved in accordance with the invention, thereby dramatically reducing the storage requirements for the waste. Further, where the waste is to be stored for subsequent use or disposal, the conditioner beneficially will render the waste more inert to reduce odors and decay, and to reduce potential problems associated with bacteria or fungus.

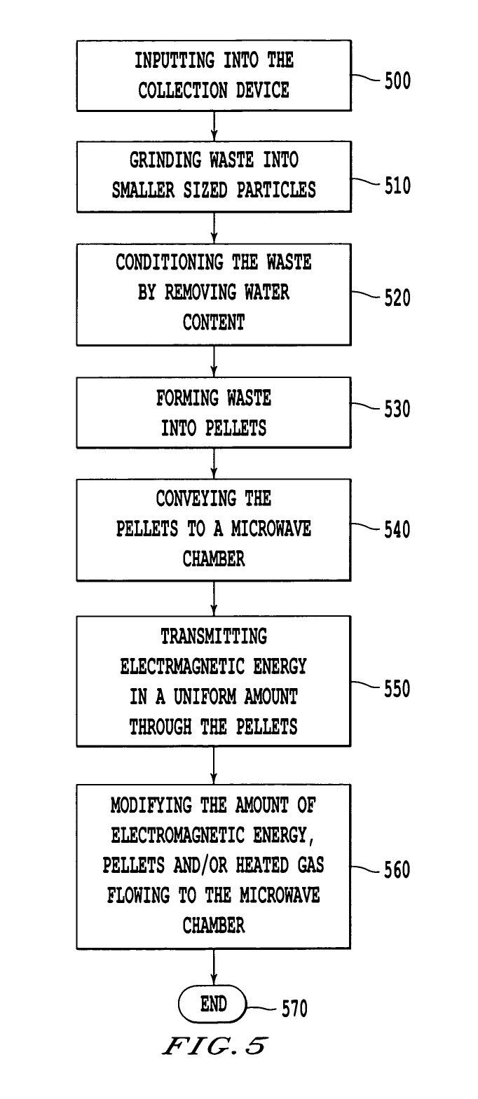

An example of a process of the present invention will now be described. FIG. 5 shows a flowchart of one embodiment of the processing method. First, in step 500, food or other waste is input into a collection device. In step 510, the food waste is then optionally ground into particles, thereby decreasing the size. In step 520, the food waste is then conditioned by reducing the water content to a desired amount, preferably by removing at least 50% to 90% of the water in the waste, and more preferably removing water such that the resulting waste is 10% or less by weight water. It is to be understood that a weight amount of water to be removed by conditioning can correspond to the characteristics of the product and/or desired use of the conditioned product. For example, when the conditioned product includes certain agricultural products (e.g., apple pomace) to be used in certain food products (such as animal feed and the like), it may be desirable for the conditioned product to be no more than about 50% water (by weight). When the conditioned product includes, for example, yeast, and the desired use is fertilizer, it may be desirable for the conditioned product to have no more than about 30% water. When the conditioned product is to be incinerated or placed into long term storage, the conditioned product may have no more than about 10% water. The conditioning includes, but is not limited to, draining excess water from the food waste and heating the food waste to create steam or vapor which flows from the food waste and drying the waste. In addition, this conditioning preferably reduces the size or granulates the waste. This heating can also beneficially reduce or eliminate live bacteria or fungus or sterilize the waste, and due to the removal of water, subsequent growth of such organisms is also reduced. Particularly, where waste is to be conditioned and then stored for subsequent disposal or later incineration, or where the waste is to later be used (e.g., for agricultural uses), it can be desirable to heat the waste to at least 212° F., and more preferably to at least 220-250° F., during the conditioning. As a result of the conditioning, or as a result of the conditioning in combination with subsequent reduction (if provided, e.g., by cutting or grinding) a food waste product is formed which can be stored for subsequent disposal or use.

In an alternative process performed in the system depicted in FIGS. 3A-3D, instead of passing heated air through the drying chamber, the drying chamber is held at a vacuum of approximately 1 to 2 PSIA. In this condition, it is possible to dry the food waste at lower temperature ranges. Typically, the temperatures used at this pressure are from approximately 100° to 150° F. At these temperatures, any plastics which might be mixed with the food waste will not melt. Melted plastics sometimes form an insulating layer on the rotors. This insulating layer can reduce system efficiency and may need to be removed by periodic maintenance. By processing the waste at lower temperatures, this potentially high maintenance problem may be avoided. It also avoids the need to vent potentially hazardous compounds released when heating causes plastics to decompose.

In one non-limiting embodiment, designated the, “vacuum drying embodiment,” the waste enters the drying chamber through an airlock to minimize the amount of air introduced to the drying chamber. When the airlock is opened to the drying chamber, the small amount of air in the airlock with the waste will rapidly expand and help to force the waste out of the airlock and into the drying chamber. In this embodiment, the dried pellets are also removed through an airlock. It is to be understood that an airlock is a device configured with a first closable opening and at least a second closable opening such that material may be introduced into a space between the first and at least second closable openings via the first closable opening while the second closable opening is closed.

Performing the drying operation at lower temperatures may result in other advantages. For example, operating at lower temperatures reduces the risk of burns to persons near the system. The system may also be more energy efficient because heat loss to the environment may be reduced (while the amount of heat required to dry to food waste is about the same as with other temperatures). Additionally, operating at lower temperatures reduces tendency of the food waste to exist in a highly viscous state. Therefore, the rotors require less torque during the drying process.

Optional steps 530-560 of FIG. 5 can also be implemented with some embodiments of the invention. In step 530, the waste is formed into pellets. As discussed above, the pellets themselves need not have any particular shape or size, but are merely some form of the solid waste ground into many pieces. In step 540, the pellets are moved to microwave radiation chamber. In optional step 550, electromagnetic energy (microwave radiation) is transmitted through the pellets. Such exposure can partially or substantially sterilize the pellets in addition to further removing moisture. Although FIG. 5 describes the amount of electromagnetic energy as “uniform,” other rates/amounts of energy can be applied. For example, a means to alter the frequency of the microwave radiation may be provided. Step 560 describes modifying the amount of electromagnetic energy, food waste pellets and/or heated gas flowing to the microwave chamber. Alternatively, the chamber may use other forms of energy to dry the pellets.

FIGS. 3A-3D further illustrate an advantageous conditioner arrangement which can be utilized in accordance with the invention. An arrangement as illustrated in FIGS. 3A-3D is particularly advantageous where there will not be any downstream incineration or if incineration is to occur at a later point and time and the waste is to be stored until incineration. The arrangement could also be used where incineration is to occur immediately or shortly after conditioning, however. Further, this arrangement can also be used without downstream cutting or grinding (although additional cutting or grinding could be provided if desired), because the product from the conditioner is of a suitable size such that it can be readily stored or distributed (e.g., for agricultural purposes). For example, the conditioner can yield a product having a size similar to coarsely ground coffee.

As shown in FIG. 3A, the waste can initially be placed into an accumulator device 801 having a lid 801a. When the accumulator is filled, when a safety cover is closed, or when conditioning is otherwise desired, the waste can then be fed to a reducing device represented at 800. In a presently preferred form, the reducing device can be in the form of a hammermill. Various expedients could be utilized for feeding the waste from the accumulator to the hammermill 800. In the illustrated arrangement, a push block 801c is provided which forces the waste toward a port connecting the accumulator to the hammermill 800. Various other expedients are possible. For example, other types of conveying devices could be utilized, or alternatively, a ramp or a simple gravity feed (for example with the waste accumulated on top of a port opening that can be selectively opened and closed so that the port can be opened when it is desired to feed the waste into the hammermill). For certain applications, the accumulator could also be omitted and waste fed directly to the hammermill. The use of an inlet receiving/conveying device as represented in FIG. 3A is preferred because the hammermill can initially be started before waste is fed thereto. Once the hammermill is up to speed, the waste can then be fed utilizing the push block or other conveying expedient. The operation of feeding and reducing the waste with the hammermill can be continuous or intermittent. With an intermittent operation, a batch of waste can be fed to the hammermill, and after this batch is processed, an additional batch is fed. In a continuous mode, the waste can be gradually fed as the hammermill continues to operate.

It has been found preferable to utilize a hammermill for the reducing device 800 with smaller sized perforated plate openings, for example, of approximately ⅛^{th} of an inch, however the invention is not limited to a particular size of opening for the hammermill. Further, it is to be understood that other types of cutting or grinding arrangements could be utilized upstream from the conditioner. As noted earlier, the cutting, grinding or milling apparatus is preferably waterless.

The consistency of the material exiting the hammermill will be that of a paste or thick slurry. This material then enters the conditioner 803 which, in the illustrated embodiment, includes a pair of finned counter-rotating (rotating in opposite directions with respect to each other) stirring elements. The conditioner 803 is shown in further detail in FIGS. 3B-3D. FIGS. 3B and 3D are perspective views of the rotor arrangement, while FIG. 3C is an end view of the apparatus. The arrows of FIG. 3A represent waste flow, while the arrows of FIG. 3B represent air/gas flow.

As shown in FIG. 3B, the rotors or stirrers 810 can include holes 810a at the center thereof to accommodate heaters, such as electrical resistance cartridge heaters. A temperature measuring device, such as a thermocouple or a resistance temperature detector (RTD) can be provided adjacent to a stationary portion of the bearings, on one or more rotor blades, or on one or more stationary blades to provide feedback for controlling the heaters. It is to be understood that various heating expedients can be provided in addition to or in lieu of heaters provided in the rotors. For example, if a steam or other heat transfer fluid is conveniently available, the heat transfer fluid can pass through the center of the rotors. If steam is used, it will be isolated from the waste by the rotors, and thus, the heat from the steam can be used to heat and dry the waste without having the moisture from the steam contact the waste.

As shown in FIG. 3B, the tray or tank 822 can be provided with strip heaters 802, and thermocouples (e.g., at locations shown at 802a) can be provided for controlling the strip heaters. Preferably, the thermocouples are provided near the material entry point, or at the wet end, however, various placement locations are possible for the thermocouples. By providing thermocouples at the wet end or the end at which the material is introduced, the addition of cooler material or material having a higher moisture content (which requires a longer amount of time or more energy to heat) can be determined, and the controller can increase the temperature or prolong the duty cycle of the heaters. If cooler or wetter material is introduced, the thermocouples could also be utilized to control the residence time or feed of the waste. Specifically, as discussed further hereinafter, rotation of the rotors will convey the waste from the upstream side or inlet of the conditioner to the downstream side (as well as breaking up, mixing, heating and granularizing the waste as discussed further herein). By reversing the rotation of the rotors, the flow of the waste can also be reversed so that waste will be retained in the upstream side (or any given portion) of the conditioner for a longer period of time, and so that waste which is being introduced into the system will be mixed with waste previously introduced. By using this forward and back or reversing rotation of the rotors, more optimal/efficient operation of the conditioner can be achieved and premature exit of an insufficiently processed waste (too wet and/or insufficiently heated) is prevented by mixing hot, dry pellets with waste that is in a very viscous state. This reduces both the drying time and the amount of motor torque needed for the rotors. The apparatus can be more compact because the residence time can be varied and is not dependent solely upon the time required for the waste to be conveyed unidirectionally from one end of the conditioner to the other.

Further, two or more zones of heaters can be utilized. For example, a first zone of heaters can be provided near the wet end. An additional set of heaters can be provided closer toward the exit, and these heaters can be maintained at higher set point temperatures in order to ensure that the material is raised to a temperature suitable for ensuring the material exiting over the weir formed by plate 834 is sufficiently dry, and if desired, sufficient to kill or reduce bacteria or fungus or to sterilize the waste.

It is to be understood, that a different numbers of rotors or stirrers could be provided. For example, more than two rotors could be utilized for a larger capacity system. It would also be possible to utilize a single rotor.

A suitable drive arrangement is also provided as represented schematically by gears 812 in the end view of FIG. 3C. It is to be understood that various drive arrangements are possible in lieu of the use of gears, for example, the use of a chain drive or belt, or coupling of a motor directly to one or more of the rotors 810. As will be described later, each of the rotors preferably includes blades 814 so that the blades 814 rotate with the rotors. The blades 814 are shown spaced at approximately 120° intervals, however different numbers of blades could be utilized. In addition, stationary blades are preferably also provided such that the rotary blades interact with the stationary blades to assist in churning and better ensure a reduced size of the product exiting the conditioner. In the example illustrated in the drawings, three sets of stationary blades are provided, a first 816 to the left of the rotor, a second 818 positioned between the rotors, and a third 820 positioned to the right of the rotors. Each of these sets of blades includes plural blades spaced along the length of the conditioner to cooperate with the blades on the rotors to mix, reduce, heat and granularize the waste.

The rotors extend in the bottom portion of a chamber or tray 822 having, as shown in FIGS. 3B and 3C a somewhat W-shaped profile. The elements identified at 824 schematically represent holders for heating elements. As noted earlier, different numbers of heating elements can be provided. As also noted earlier, in one non-limiting embodiment, separately controllable heating elements are provided at different longitudinal positions of the conditioner, so that the energy at different regions can be controlled (alternately, certain heating elements could extend along the entire length, but others could be of shorter lengths so that they may be separately controlled). This separate control arrangement can be advantageous, for example, because more energy might be desirable at the inlet portion of the conditioner where the waste has not been heated and contains a larger amount of water that needs to be removed. Additionally as noted above, it may be desirable to include more than one heating element along the length of the rotors so that separate control can be provided for the heating elements at different locations along the length of the conditioner. This can be achieved, for example, by providing one heating element extending from one end of the rotor and another heating element extending from the other end of the rotor. It is also to be understood that some or all of the heating elements through the rotors or disposed outside of the housing could also be provided in the form of passageways for a heat exchange fluid if a suitable heat exchange fluid is available in the location at which the conditioner is to be utilized. Additional heating elements can also be provided at other locations. For example, according to a preferred form, additional heating elements could be provided in the top of the conditioner as represented schematically at 832 in FIG. 3C. In addition, as discussed earlier, microwave heating could also be used.

As indicated generally by the arrow (indicating waste flow) at the left of the conditioner in FIG. 3A, an inlet opening is provided through the top of the conditioner. Alternately, the inlet opening could be provided through a side wall if desired. As shown in FIG. 3C and at the right of FIG. 3A, a plate 834 is provided to define a top shelf or ledge which acts as a weir so that the waste exiting the conditioner will flow over the top shelf of the weir. As indicated at 836 (FIG. 3C), a number of threaded apertures could be provided to fasten different sizes of weir plates, and the weir plates could have different configurations. For example, a V-notch or other configuration could be provided. Further, threaded apertures 836 can be provided to secure additional plates to reduce the size of the opening above the weir plate 834 to reduce heat losses. For example, a plate could extend across the top pair or top two pairs of threaded fastener openings so that a slot opening is provided above the weir. Thus, the conditioned waste can fall over the edge of the weir and into a suitable storage location, e.g., via a ramp 805 (FIG. 3A) or a conveyor to convey the waste to a suitable storage location. It is to be understood that other exit arrangements are also possible. For example, in lieu of utilizing a weir-type flow out of the container, an exit opening could be provided at the bottom or underneath of the rotors on the downstream side of the conditioner so that the processed waste exits from the bottom of the rotors and into a container, and the waste could then be conveyed from the container by a suitable conveying device, for example, an auger or other feed device. Alternately, a conveyor device (e.g., a screw or auger feed) could be provided, e.g., at the bottom of the conditioner under the rotors, for conveying waste out of the conditioner. In addition, although the weir plate is illustrated as a separate plate, the weir plate could also be integral with the end plate or end wall of the conditioner.

As noted earlier, preferably a series of fixed blades 816 are provided to the left of the rotors, with an additional series of blades 820 provided to the right of the rotors. Further, blades are provided between the rotors as represented at 818 in FIGS. 3B and C. The blades could also be in the form of acute blades extending about portions of the peripheries of the rotors. Thus, as should be apparent, with this arrangement, the waste will encounter interactions between the rotating blades between the two rotors, as well as interaction between the rotating blades and the fixed blades to the left and to the right of the rotors, and also between the rotating blades and the fixed blades between the two rotors. In addition to assisting in breaking up of the food waste and/or churning/mixing of the waste, large contact areas are provided for heating the waste by virtue of the heating of the lower region of the chamber and the fixed blades as well as the heating of the rotors and the conduction of the heat to the blades of the rotors. Thus, a large surface area is provided for heating of the waste passing through the arrangement. Although the blades of the rotors are shown aligned in rows, they may be offset from one another. For example, the blades closest to the downstream end could be offset from the next adjacent blades by 20 or 30° (or another angle), with the next set of blades also offset. The blades of the rotors are preferably inclined, such that they are not exactly perpendicular to the axis of the rotors. This incline assists in ensuring movement of the waste toward the downstream or exit side of the conditioner, and also to assist in ensuring movement of the waste such that the rotors do not simply carve channels into a mass of non-moving waste, which could potentially occur at the inlet side of the conditioner before the waste has been dried and formed into a more granular or pellet-like material. The provision of inclinations on the blades at the downstream side may be less important, as the flow of the mass commenced at the upstream side can force the waste to move at the downstream side and thereby ensure movement of the waste along the length of the conditioner. Preferably, at least the blades at the upstream side of the conditioner have an inclination toward the downstream side of, for example, up to around 10°, and more preferably from 1 to 5°. The blades can be inclined along the entire length, however as discussed above, inclination of the blades on the downstream end will typically be less important. Steeper inclinations could be utilized, but excessively steep inclinations could be undesirable in that the waste could be passed too quickly from the upstream side to the downstream side, allowing insufficient time for conditioning of the waste by heating and churning or macerating.

In order to increase the amount of time provided in the conditioner, the direction of rotation of the blades may be reversed. By way of example only, and not to be construed as limiting, the blades may be rotated in one direction for a minute, and then rotation may be reversed for 15 seconds. This reversing movement can increase the time provided in the conditioner for a given length of the conditioner, thereby allowing the conditioner to be more compact while nevertheless ensuring movement, heating and maceration of the waste. Also, as noted earlier, if the waste requirements are increased, the size of the equipment can be scaled up, or alternatively, additional rows of rotors could be provided. By way of example only, and not to be construed as limiting, an arrangement having rotors of approximately four feet in length, with an outlet opening of approximately one foot will be of a size sufficient to handle approximately 185-200 pounds of waste per day. Where larger amounts of waste are to be handled, multiple conditioners could also be utilized in additional to, or in lieu of, scaling up of the size of a given conditioner.

By way of example, according to one preferred form, one of the rotors can have a left-hand pitch and the other can have a right hand pitch. The arc of the tip of the stirrers intersect with one-another, but do not interfere. They also intersect but do not interfere with the three rows of stationary fins. The stationary fins can have several distinct functions, dependent upon the stage of drying taking place at the location of a given fin or series of fins. In the wet end, the stationary fins can also prevent the material, which is beginning to increase in viscosity as it heats, from co-rotating with the stirrers. In the center area of the dryer were the material can be extremely plastic (taffy-like), the stationary fins provide a shearing action which, in turn, begins the formation of wet granules. In the second zone of the dryer, where dry granulation occurs, the clearance between stationary and rotating fins is preferably deliberately reduced, resulting in further milling of the granules and increased drying efficiency.

The transition from the shearing stage to the wet granulation stage and the transition between wet granulation and dry granulation can be greatly enhanced by the periodic reversal in the rotational direction of the stirrers. The pitch of the counter rotating stirrers provides longitudinal blending of the waste between these stages when the stirrers are reversed for a period of time according to a predetermined schedule.

In the illustrated example, airflow through the conditioner is illustrated in FIG. 3B. The air inlet (represented by arrow 806) is located near the middle of the sidewall of the outer jacket. The air sweeps under the tray 822, past the tray heaters, and then upward to the top of the dryer, where it enters the cover. The air is then directed past a radiant panel 832 and into the tray where it sweeps over the bed of drying material, absorbing moisture, and ultimately back through the cover and into an external odor control unit, with the air/exhaust exit represented by arrow 807. As has been discussed herein, it is to be understood that many variations are possible. For example, if a steam source is readily available, the region surrounding the exterior of the tray 822 could be supplied with steam from a steam source, in which case this region would be isolated from the interior of the tray 822. Thus, the walls of the tray or the jacket of the conditioner can be heated with steam to provide heat for heating the waste, but the steam is isolated from the waste so that moisture is not added to the waste by the steam. With this configuration, a separate source of air would then be provided to pass through the interior of the tray or the wall of the interior of the conditioner so that the dry, heated air can carry away moisture liberated from the waste, while the steam or other heat transfer fluid which heats the walls 822 containing the waste is kept out of contact with the waste.

The spacing between the fixed and rotating blades can also vary. An arrangement in which the spacing is approximately one-half inch at the upstream side has been found satisfactory. As noted above, the spacing between the rotating and the fixed blades at the downstream side is preferably decreased, e.g., such that the spacing is decreased to about ⅛^{th} of an inch at the downstream end. The fin to fin spacing of the adjacent rotors can be, for example, approximately 1.5 inches.

To ensure adequate thermal treatment of the waste, preferably the waste will be within the apparatus for approximately twelve hours, however, the amount of time could vary substantially. Further, temperature sensors are preferably provided at various locations along the length of the conditioner, for example, with temperature sensors provided in the center fins or blades 818 between the rotors. For example, in a current arrangement, a temperature sensor can be provided every third or fourth blade, however, as performance knowledge increases with experience, the number of temperature sensors could be reduced. These temperature sensors can be utilized to provide feedback as to the progress of the conditioning of the waste. Such feedback can be utilized to control the heating elements and/or rotation of the waste. For example, where the waste is extremely wet (e.g., in a restaurant where soup or meals with large amounts of sauce were served at a given meal), the water content may be significantly higher than another meal. Accordingly, additional heat energy might be needed, particularly at the inlet end of the conditioner. Alternatively, a greater amount of reverse rotation time could be provided so that the waste will progress more slowly through the apparatus so that it can be ensured that the moisture will be sufficiently eliminated and the waste will be sufficiently heated prior to exiting the conditioner. For example, where the temperature sensors sense the waste is maintained at temperature of, for example, 212° F., it will be apparent that a large amount of water is present in the waste such that the heat is being utilized to eliminate the moisture. Preferably, at least a portion of the conditioner will achieve temperatures exceeding 220° F., more preferably above 250° F., and even more preferably, a maximum temperature of 260° F. will be sensed in at least a portion of the conditioner.

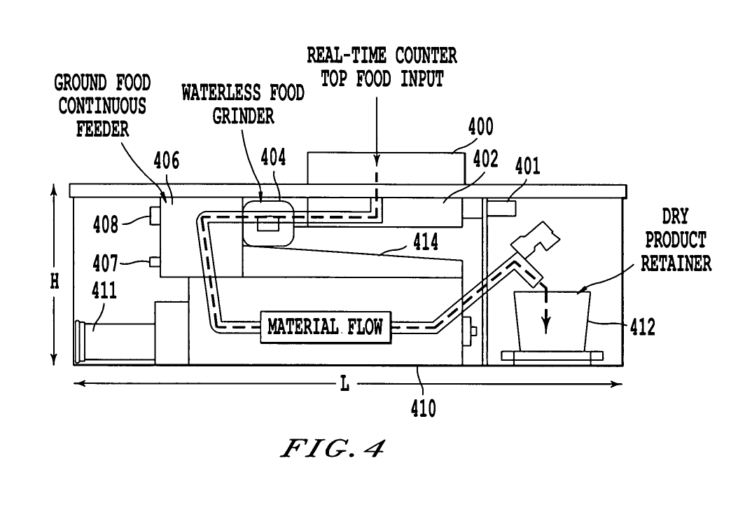

FIG. 4 depicts another example of an arrangement according to the invention. With the arrangement of FIG. 4, the food can be input into a collection device as indicated at 400. A motor 401 turns an auger represented at 402 to forward the waste to a waterless grinder, such as a hammermill 404 as described earlier. With this arrangement, the auger 402 can operate continuously if food is regularly being introduced, for example, during or after a meal to a group. Alternatively, the auger can be turned on selectively as the food is introduced. This arrangement is advantageous in that the food is forwarded to the grinder as soon as it is introduced into the system so that it does not accumulate at a location at which odors can be generated. The food exiting the grinder is then forwarded to a storage or feeding device 406 which intermittently or continuously feeds the ground material to the conditioner represented at 410. After passing through the conditioner, the waste can then be fed by an auger, by the force of the waste movement itself (the conveying force of the waste), or by other suitable expedients to a storage bin 412. As discussed earlier, such a bin can be periodically removed and dumped, or the bin can be removed and serve as a storage container. Alternatively, as also discussed earlier, a trap door could be provided underneath the bin, so that the contents of the bin exit through the bottom of the bin when the trap door is opened. As represented at 411, a motor can be provided for driving, for example, bladed rotors as discussed earlier in conjunction with FIGS. 3A-3D. In accordance with another advantageous feature of the FIG. 4 arrangement, a plenum 414 is disposed above the conditioner so that air exiting the conditioner (carrying with it the moisture that has been liberated from the waste) exits through the plenum and is used to pre-heat or pre-warm the waste in the storage/feeder compartment 406. Preferably, the moist air exiting through the plenum 414 will not directly contact the waste in the storage/feeder location 406, although direct contact could be possible. In a preferred form, the jacket surrounds the physical location at which the waste is stored in the device 406, for example, with a double-walled arrangement and with the warm moist air from the plenum 414 passing between the walls. Two outlets are schematically represented at 407, 408, with the outlet 407 providing a drain for moisture which has condensed and outlet 408 providing a gas outlet for the moist air. The outlets can be connected to a location between the walls of a double-walled arrangement.

According to another advantageous feature of the FIG. 4 arrangement, the air/gas flow is such that a slightly negative pressure is provided at the input of the conditioner and the food storage/feeding device 406, so that air/gases will tend to move from the location the food is input toward the conditioner, and thereafter, the air passes through the plenum 414 (along with the any additional air that may have been introduced into the system in the conditioner), and then the air will exit through the plenum 414 and be used for heating the food at 406. Thus, odors will not be exiting through the food input location 400 because air is preferably being drawn into the system at that point. Preferably, suitable odor control expedients will be associated with the exit 408.

By way of example, a device as shown in FIG. 4 can have a length L of approximately 100 inches and a height H of approximately 36 inches. Such dimensions are provided by way of example only. As noted earlier, the size of the system and various components can be varied.

It is to be understood that any of the above-discussed embodiments of the waste treatment system can be used in various locations, and are not limited to use in restaurants and ships. Rather, the various embodiments can be used in any setting in which waste treatment is desired, such as where a compact, self-contained, waste treatment system would be desirable. It is to be further understood that any of the embodiments of the waste treatment system can be designed so as to be compact and/or to have a relatively small footprint or height, such that the system can be installed underneath a countertop.

Numerous modifications and variations of the present invention are possible in light of the above teachings. It is therefore to be understood that within the scope of the appended claims, the invention may be practiced otherwise than as specifically described herein.

1. A treatment apparatus, comprising:
an accumulator configured to accumulate waste and to deliver the accumulated waste in a continuous manner; and
a conditioner which receives the accumulated waste and heats the waste to remove liquid from the waste, the conditioner comprising a set of cooperating blades which convey the waste through the conditioner.

2. The treatment apparatus according to claim 1, further comprising:
a dryer configured to heat the waste in the conditioner.

3. The treatment apparatus according to claim 2, wherein the dryer comprises at least one electrical resistance heater disposed on at least one of an outside wall of the conditioner and in a center of a rotor.

4. The treatment apparatus according to claim 2, wherein the dryer comprises a heat transfer fluid flowing by at least one of an outside wall of the conditioner and a center of a rotor.

5. The treatment apparatus according to claim 2, wherein the dryer comprises a microwave source.

6. The treatment apparatus according to claim 2, wherein the dryer comprises a vacuum chamber with first and second airlocks and the waste is introduced through the first airlock and removed through the second airlock.

7. The treatment apparatus according to claim 1, further comprising:
a channel configured to receive steam to heat air in the conditioner.

8. The treatment apparatus according to claim 7, wherein the channel is disposed on an outside wall of the conditioner.

9. The treatment apparatus according to claim 8, further comprising:
a second channel configured to receive the heated air from the conditioner to preheat the accumulated waste in the accumulator.

10. The treatment apparatus according to claim 1, wherein a weight percentage of the liquid in the waste after drying in the conditioner is no more than 50%.

11. The treatment apparatus according to claim 10, wherein the weight percentage of the liquid in the waste after drying in the conditioner is no more than 30%.

12. The treatment apparatus according to claim 11, wherein the weight percentage of the liquid in the waste after drying in the conditioner is no more than 10%.

13. The treatment apparatus according to claim 1, further comprising:
a grinder configured to grind the accumulated waste prior to receipt of the waste by the conditioner.

14. The treatment apparatus according to claim 13, wherein the grinder is a hammermill.

15. The treatment apparatus according to claim 13, wherein the grinder, accumulator, and conditioner are located in a single integrated apparatus.

16. The treatment apparatus according to claim 1, further comprising:
a grinder configured to grind the waste after the waste is output from the conditioner.

17. The treatment apparatus according to claim 1, wherein the conditioner comprises a first plurality of movable blades disposed on a first shaft, a second plurality of movable blades disposed on a second shaft, and a first plurality of fixed blades disposed between the first and second plurality of movable blades.

18. The treatment apparatus according to claim 17, wherein the conditioner comprises a second plurality of fixed blades disposed adjacent the first shaft and a third plurality of fixed blades disposed adjacent the second shaft.

19. The treatment apparatus according to claim 17, further comprising:
a controller configured to operate a motor to rotate the first shaft in a first direction and in a second direction opposite the first direction.

20. The treatment apparatus according to claim 17, further comprising:
a controller configured to operate at least one motor to rotate the first and second shafts to move the waste in a first direction in the conditioner.

21. The treatment apparatus according to claim 20, wherein the controller is configured to operate the at least one motor to rotate the first and second shafts to move the waste in a second direction opposite the first direction in the conditioner.

22. The treatment apparatus according to claim 17, wherein at least one of the first plurality of movable blades and the second plurality of movable blades extends in a direction non-perpendicular to an axis of the first or second shaft.

23. The treatment apparatus according to claim 22, wherein the at least one of the first plurality of movable blades and the second plurality of movable blades is inclined toward a downstream side of the conditioner.

24. The treatment apparatus according to claim 22, wherein a space between a blade of the first plurality of movable blades and an adjacent blade of the first plurality of fixed blades in a first area of the conditioner is greater than a space between another blade of the first plurality of movable blades and an adjacent blade of the first plurality of fixed blades in a second area of the conditioner.

25. The treatment apparatus according to claim 17, wherein at least one of the first shaft, the second shaft and the first plurality of fixed blades is configured to be heated.

26. The treatment apparatus according to claim 17, wherein walls of the conditioner are configured to be heated.

27. The treatment apparatus according to claim 1, further comprising:
a receptacle configured to receive waste; and
a grinder disposed between the receptacle and the accumulator, the grinder configured to receive the waste from the receptacle, to grind the waste, and to deliver the ground waste to the conditioner.

28. The treatment apparatus according to claim 1, wherein the accumulator comprises a waste receiving opening disposed at counter height.

29. The treatment apparatus according to claim 1, wherein the treatment apparatus is sized and shaped to be disposed under a counter.

30. The treatment apparatus according to claim 1, wherein the treatment apparatus is scaleable to accommodate changes in an amount of waste processed.

31. A method of treating waste, comprising:
accumulating waste in a non-continuous manner;
delivering the waste to a conditioner in a continuous manner;
heating the waste in the conditioner to remove liquid from the waste; and
conveying the waste through the conditioner with a set of cooperating blades.

32. The method of treating waste according to claim 31, further comprising:
preheating the waste accumulated in a non-continuous manner.

33. The method of treating waste according to claim 32, wherein the waste is preheated with heat transferred from the conditioner.

34. The method of treating waste according to claim 33, wherein the waste is preheated before entering the conditioner by steam driven off of waste in a drying process and by circulating air that is heated by the drying process.

35. The method of treating waste according to claim 31, further comprising grinding the waste.

36. The method of treating waste according to claim 35, wherein grinding the waste is performed without adding fluid to the waste.

37. The method of treating waste according to claim 34, wherein heat from the conditioner is recovered and used for a secondary process.

38. The method of treating waste according to claim 37, wherein the secondary process is preheating air supplied to the conditioner.

39. The method of treating waste according to claim 37, wherein the secondary process is heating a storage component for ground waste via air heated in the conditioner.

40. The method of treating waste according to claim 31, further comprising:
automatically conveying waste through a grinder; and
temporarily storing the waste before heating the waste in the conditioner.

41. The method of treating waste according to claim 31, wherein the conveying comprises automatically conveying waste through the conditioner in each of the forward and reverse directions sufficiently to blend dry waste with waste that is still wet.

42. A treatment apparatus, comprising:
An accumulator configured to accumulate waste and to deliver the accumulated waste in a continuous manner to a means for receiving the accumulated waste;
means for receiving the accumulated waste; and
means for heating the waste to remove liquid from the waste.
